(19) United States
(12) Patent Application Publication
(10) Pub. No.: US 2026/0147254 A1
(43) Pub. Date: May 28, 2026

(54) CAMERA MODULE

(71) Applicant: SAMSUNG ELECTRO-MECHANICS CO., LTD., Suwon-si (KR)

(72) Inventor: Yong Wan CHO, Suwon-si (KR)

(73) Assignee: SAMSUNG ELECTRO-MECHANICS CO., LTD., Suwon-si (KR)

(21) Appl. No.: 19/369,661

(22) Filed: Oct. 27, 2025

(30) Foreign Application Priority Data
Nov. 28, 2024 (KR) 10-2024-0173334

(51) Int. Cl. G03B 13/36; G03B 30/00

(52) U.S. Cl. CPC G03B 13/36; G03B 30/00

(57) ABSTRACT

A camera module includes a housing, a carrier disposed in the housing and configured to move in an optical axis direction with respect to the housing, a lens unit disposed in the carrier and configured to move in the optical axis direction together with the carrier, a guide member disposed between the carrier and the housing, that contacts both the carrier and the housing, and a ball damper disposed spaced apart from the guide member in a direction perpendicular to an optical axis. The ball damper is configured to move in the carrier, and a gap is formed between the ball damper and the housing according to a position of the ball damper, in a direction perpendicular to the optical axis.

### CROSS-REFERENCE TO RELATED APPLICATIONS

This application claims the benefit under 35 USC 119(a) of Korean Patent Application No. 10-2024-0173334 filed on Nov. 28, 2024, in the Korean Intellectual Property Office, the entire disclosure of which is incorporated herein by reference for all purposes.

### BACKGROUND

### 1. Field

The present disclosure relates to a technology for a camera module.

### 2. Description of the Background

Recently, camera modules mounted on portable terminals are becoming increasingly high-performance. Accordingly, the size and weight of the lens unit and the driving unit driving the lens unit are also increasing.

On the other hand, the increased weight of the parts has the problem of being vulnerable to impacts. For example, the increased impact force increases the possibility of damage and breakage of the parts, making it difficult to secure shock-resistant reliability.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a carrier disposed in the housing and configured to move in an optical axis direction with respect to the housing, a lens unit disposed in the carrier and configured to move in the optical axis direction together with the carrier, a guide member disposed between the carrier and the housing, that contacts both the carrier and the housing, and a ball damper disposed spaced apart from the guide member in a direction perpendicular to an optical axis. The ball damper is configured to move in the carrier, and a gap is formed between the ball damper and the housing according to a position of the ball damper, in a direction perpendicular to the optical axis.

A side surface of the carrier may be supported by the housing in a first axis direction, perpendicular to the optical axis, other side surfaces of the carrier may be spaced apart from the housing in a direction perpendicular to the optical axis by a first gap, a second gap between the ball damper and the housing in a direction perpendicular to the optical axis, may be configured to be always less than the first gap formed between the other side surfaces of the carrier and the housing in the direction perpendicular to the optical axis.

the guide member may be disposed on a side surface of the carrier, and the ball damper may be disposed to be opposite the guide member based on a virtual straight line passing through a center of the lens unit and extending in a second axis direction, perpendicular to both the optical axis and the first axis.

The carrier may include a receiving groove, the receiving groove may include a space, and the ball damper may be disposed in the space and face a side surface of the housing.

The receiving groove may include a plurality of side surfaces facing one side surface of the housing, and the ball damper may be movable between the one side surface of the housing and the plurality of side surfaces of the receiving groove, in a direction, perpendicular to the optical axis.

The ball damper may include a plurality of ball dampers, and the plurality of ball dampers may be disposed spaced apart from each other in the second axial direction.

The carrier may include a plurality of receiving grooves disposed to be spaced apart from each other in the second axial direction, and the plurality of ball dampers may be disposed in the plurality of receiving grooves, respectively.

The camera module may further include a first magnetic member disposed on the side surface of the carrier, and a second magnetic member disposed on the housing to face the first magnetic member in the first axial direction, wherein the side surface of the carrier may be supported on the housing by attractive force generated between the first magnetic member and the second magnetic member.

The guide member may include a first ball group including a plurality of balls arranged in the optical axis direction, and a second ball group including a plurality of balls arranged in the optical axis direction, and spaced apart from the first ball group in the second axial direction with the first magnetic member interposed therebetween.

The first magnetic member may be a driving magnet, the housing may include a driving coil to face the driving magnet in the first axial direction, the driving magnet and the driving coil may be configured to generate a driving force that moves the carrier in the optical axis direction.

The camera module may further include a case coupled to the housing, wherein the case may include damper members protruding toward the guide member and the ball damper facing the guide member and the ball damper in the optical axis direction, respectively.

The damper member may be formed of an elastic material.

In another general aspect, a camera module includes a housing, a carrier disposed in the housing and movable in an optical axis direction with respect to the housing, a lens unit disposed in the carrier and movable in the optical axis direction together with the carrier, a guide member including a plurality of balls arranged in the optical axis direction and disposed between the housing and the carrier, and a ball damper disposed in the carrier such that a portion of the ball damper is disposed between the housing and the carrier. The guide member rolls in the optical axis direction, and the ball damper rolls at least on a plane, perpendicular to an optical axis.

The carrier may be supported on the housing in a first axis direction, perpendicular to the optical axis, with the guide member therebetween, and the guide member and the ball damper may be disposed to be spaced apart from each other in the first axis direction.

The guide member and the ball damper may be disposed on opposite sides of the carrier from each other based on a virtual straight line extending in a direction, perpendicular to the optical axis passing through a center of the lens unit.

The camera module may further include a case coupled to the housing, wherein the carrier may include a receiving groove in which the ball damper is disposed and which includes a bottom surface facing the case in the direction of the optical axis and a plurality of side surfaces facing the housing in a direction, perpendicular to the optical axis.

Other features and aspects will be apparent from the following detailed description, the drawings, and the claims.

### BRIEF DESCRIPTION OF DRAWINGS

FIG. 1 is a perspective view of a camera module according to an embodiment.

FIG. 2 is an exploded perspective view of a camera module according to an embodiment.

FIG. 3 is a perspective view of a lens unit according to an embodiment.

FIG. 4 is an exploded perspective view of a driving unit according to an embodiment.

FIG. 5 is a cross-sectional view taken along line I-I′ of FIG. 1.

FIG. 6 is a cross-sectional view taken along line II-II′ of FIG. 1.

FIG. 7 is a cross-sectional view taken along line III-III′ of FIG. 5.

FIG. 8 is an enlarged view of part A of FIG. 5.

FIG. 9A and FIG. 9B are drawings illustrating positions of ball dampers according to an embodiment.

FIG. 10 and FIG. 11 are drawings illustrating modified examples of part A of FIG. 5.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In addition, in the description below, “optical axis direction” may refer to the optical axis direction of the lens, and may correspond to “Z-axis direction,” “up-down direction,” etc.

An aspect of the present disclosure is to provide a camera module with improved shock resistance.

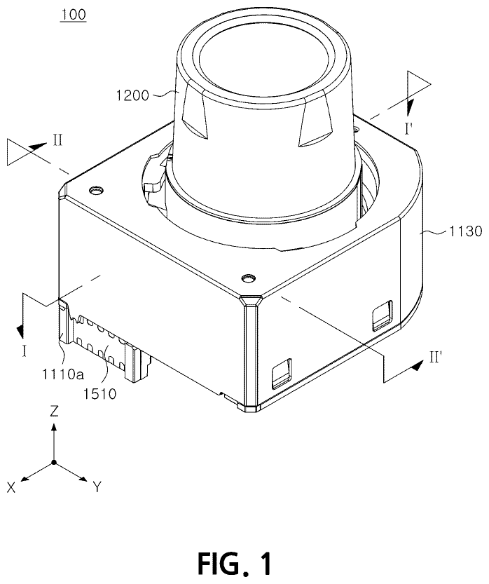

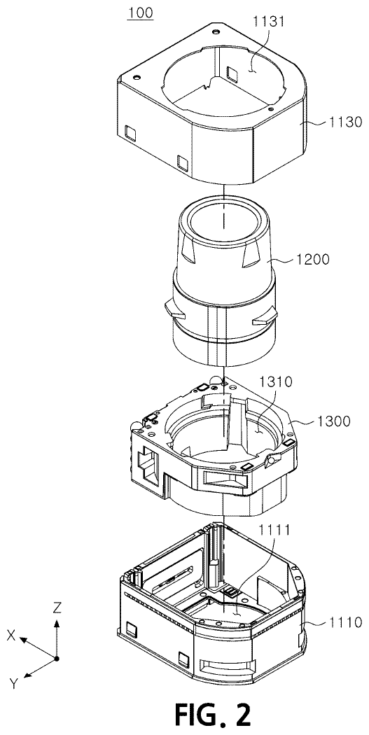

FIG. 1 is a perspective view of a camera module according to an embodiment, and FIG. 2 is an exploded perspective view of a camera module according to an embodiment.

A camera module 100 according to an embodiment may be employed in a mobile device such as a smartphone.

The camera module 100 according to an embodiment may include a housing 1110 and a case 1130 forming the exterior of the camera module 100.

The housing 1110 may be open in the direction of the optical axis (Z-axis) and may have an internal space.

The case 1130 may be coupled to the housing 1110. For example, the case 1130 may be coupled to the housing 1110 to cover the internal space of the housing 1110.

In addition, the camera module 100 according to an embodiment may include a lens unit 1200 and a carrier 1300.

The lens unit 1200 may include a plurality of lenses arranged in the direction of the optical axis (Z-axis) and a lens barrel in which the plurality of lenses are mounted.

The lens unit 1200 may be disposed in the carrier 1300. For example, the carrier 1300 may include an opening 1310 open in the direction of the optical axis (Z-axis), and the lens unit 1200 may be disposed in the opening 1310.

The lens unit 1200 and the carrier 1300 may be disposed in the internal space of the housing 1110. The lens unit 1200 and the carrier 1300 may be moved relative to the housing 1110 in the direction of the optical axis (Z-axis).

Meanwhile, the housing 1110 and the case 1130 may be fixed members that do not move.

Although not illustrated in the drawing, the camera module 100 according to an embodiment may include an image sensor.

The image sensor may be disposed on the bottom surface of the housing 1110. For example, the housing 1110 may include a through-hole (first through-hole) 1111 open in the direction of the optical axis (Z-axis) on the bottom surface, and the image plane of the image sensor may be exposed to the internal space of the housing 1110 through the first through-hole 1111.

The image sensor may be disposed along with the lens unit 1200 in the direction of the optical axis (Z-axis), and the center of the image plane may be located approximately near the optical axis (Z-axis), in detail, on the optical axis (Z-axis). Light reflected from an external subject may pass through a plurality of lenses to reach the image plane of the image sensor, and may be converted into an electrical signal.

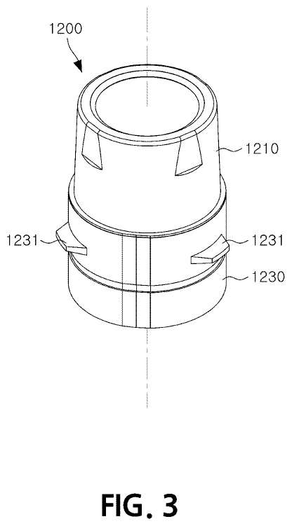

FIG. 3 is a perspective view of a lens unit according to an embodiment.

According to an embodiment, the lens unit 1200 may include a first lens barrel 1210 and a second lens barrel 1230 disposed in the optical axis (Z-axis) direction.

The first lens barrel 1210 and the second lens barrel 1230 may have a cylindrical shape having a length in the optical axis (Z-axis) direction.

At least one lens may be arranged in the optical axis (Z-axis) direction inside the first lens barrel 1210 and/or the second lens barrel 1230.

The first lens barrel 1210 and the second lens barrel 1230 may be coupled to each other. For example, one end of the first lens barrel 1210 in the longitudinal direction may be inserted into the second lens barrel 1230.

The second lens barrel 1230 may be coupled to the carrier 1300. For example, the outer peripheral surface of the second lens barrel 1230 may be provided with a plurality of coupling protrusions 1231, and the plurality of coupling protrusions 1231 may be coupled with the carrier 1300 in the mounting groove 1320.

Meanwhile, as illustrated in FIG. 1, the first lens barrel 1210 may protrude outwardly of the case 1130. For example, the case 1130 includes a through-hole (third through-hole) 1131 open in the direction of the optical axis (Z-axis), and the first lens barrel 1210 may protrude outside by passing through the third through-hole 1131.

The camera module 100 according to an embodiment may have an auto-focusing function. The auto-focusing function may be implemented through movement of the lens unit 1200 and the carrier 1300 in the optical axis (Z-axis) direction.

To this end, the camera module 100 according to an embodiment may include a focusing drive unit (hereinafter, “driving unit”) 1400 configured to generate a driving force for driving the lens unit 1200 and the carrier 1300.

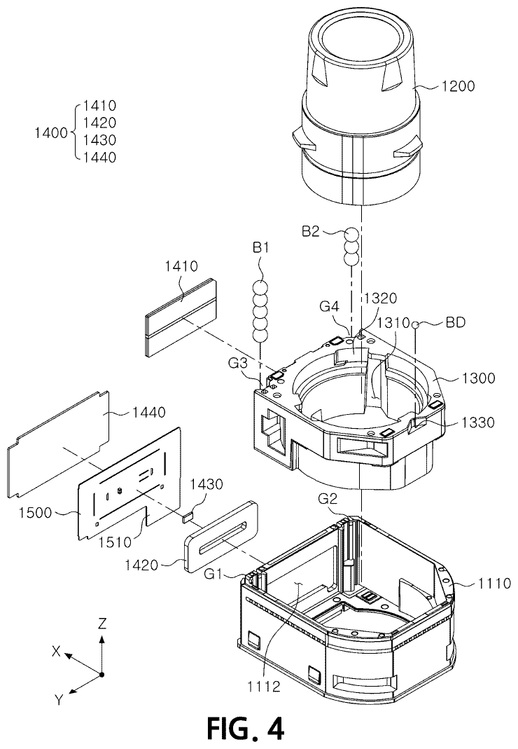

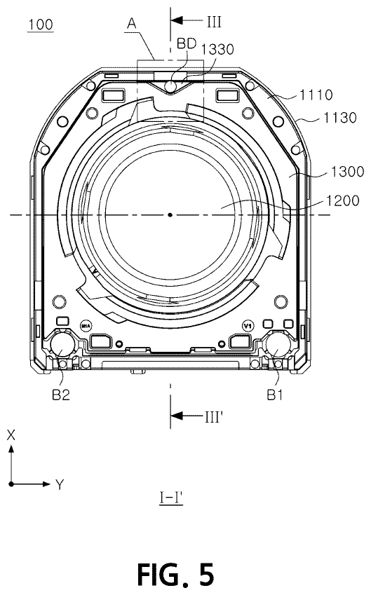

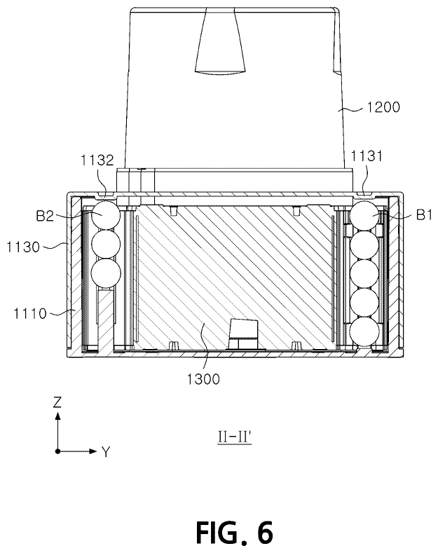

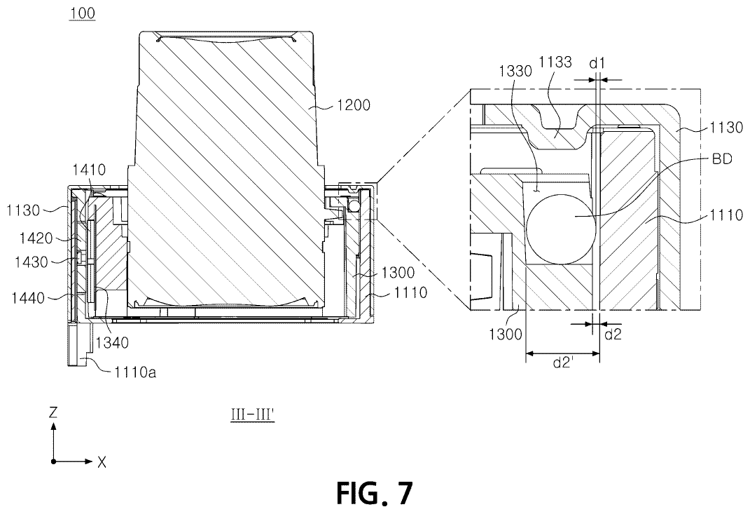

FIG. 4 is an exploded perspective view of the driving unit according to an embodiment, FIG. 5 is a cross-sectional view taken along line I-I′ of FIG. 1, FIG. 6 is a cross-sectional view taken along line II-II′ of FIG. 1, and FIG. 7 is a cross-sectional view taken along line III-III′ of FIG. 5.

Referring to FIG. 4, the driving unit 1400 may include a driving magnet 1410 and a driving coil 1420 disposed facing each other.

The driving magnet 1410 may be disposed on one side surface of the carrier 1300, and the driving coil 1420 may be disposed on one side surface of the housing 1110 facing the one side surface of the carrier 1300. For example, the driving magnet 1410 and the driving coil 1420 may face each other in the direction of the first axis (X-axis) perpendicular to the optical axis (Z-axis).

The driving coil 1420 may be disposed on the housing 1110 via the substrate 1500. For example, the housing 1110 may include a through-hole (second through-hole) 1112 open in the first axis (X-axis) direction on one side surface, and the substrate 1500 may be disposed on one side surface of the housing 1110 so that the driving coil 1420 is exposed to the internal space of the housing 1110 through the second through-hole 1112.

The substrate 1500 may include a first extension portion 1510 extending from a portion of one side thereof in the optical axis (Z-axis) direction. The housing 1110 may also include a second extension portion 1110a extending from one side surface of the housing 1110 in the optical axis (Z-axis) direction, and the first extension portion 1510 may be disposed on the second extension portion 1110a.

In an embodiment, the case 1130 may be formed of a material including metal. The case 1130 may be grounded to the pad provided in the first extension portion 1510, and thus an electromagnetic shielding function may be realized.

An N pole region and an S pole region may be provided on one side of the driving magnet 1410 facing the driving coil 1420. For example, an N pole region (or S pole region), a neutral region, and an S pole region (or N pole region) may be provided in order in the optical axis (Z-axis) direction on one side of the driving magnet 1410.

When power is applied to the driving coil 1420, the driving magnet 1410 and the driving coil 1420 may generate driving force through interaction.

The driving magnet 1410 and the driving coil 1420 may generate driving force in a direction perpendicular to the direction in which they face each other. For example, the driving magnet 1410 and the driving coil 1420 may face each other in the first axis (X-axis) direction and generate a driving force in the optical axis (Z-axis) direction perpendicular to the first axis (X-axis) direction.

The lens unit 1200 and the carrier 1300 may move in the optical axis (Z-axis) direction with respect to the housing 1110 by the driving force generated by the driving magnet 1410 and the driving coil 1420. The distance between the plurality of lenses and the image sensor may change due to the movement of the lens unit 1200 and the carrier 1300 in the optical axis (Z-axis) direction, thereby adjusting the focus.

Meanwhile, in an embodiment, the driving magnet 1410 may be a movable member that is disposed on the carrier 1300 and moves in the optical axis (Z-axis) direction together with the carrier 1300, and the driving coil 1420 may be a fixed member that is disposed on the housing 1110. However, the positions thereof may also be changed so that the driving magnet 1410 becomes a fixed member and the driving coil 1420 becomes a movable member.

Between the carrier 1300 and the housing 1110, a guide member that guides the movement of the carrier 1300 in the direction of the optical axis (Z-axis) may be disposed. For example, the guide member may include a first ball group B1 and a second ball group B2.

The guide member may be respectively disposed on both sides of the driving magnet 1410 in the longitudinal direction. For example, the first ball group B1 may be disposed on one side of the driving magnet 1410 in the longitudinal direction, and the second ball group B2 may be disposed on the other side thereof in the longitudinal direction. The driving magnet 1410 may have a length in the direction of the second axis (Y-axis) that is perpendicular to both the optical axis (Z-axis) and the first axis (X-axis). Therefore, the first ball group B1 and the second ball group B2 may be disposed to be spaced apart from each other in the second axis (Y-axis) direction.

The first ball group B1 and the second ball group B2 may each include a plurality of balls arranged in the direction of the optical axis (Z-axis).

In an embodiment, the first ball group B1 and the second ball group B2 may include different numbers of ball(s). For example, the first ball group B1 may include a greater number of ball(s) than that of the second ball group B2.

The housing 1110 and the carrier 1300 may include a guide groove extending in the direction of the optical axis (Z-axis) to accommodate the first ball group B1 and the second ball group B2.

In an embodiment, one side surface of the housing 1110 may include a first guide groove G1 and a second guide groove G2 that are spaced apart in the direction of the second axis (Y-axis). One side surface of the carrier 1300 may include a third guide groove G3 facing the first guide groove G1 and a fourth guide groove G4 facing the second guide groove G2. The third guide groove G3 and the fourth guide groove G4 may also be disposed spaced apart in the second axis (Y-axis) direction on the one side surface of the carrier 1300.

A first ball group B1 may be disposed between the first guide groove G1 and the third guide groove G3. The first guide groove G1 and the third guide groove G3 may face each other in the first axis (X-axis) direction with the first ball group B1 interposed therebetween, and at least some of the plurality of ball(s) constituting the first ball group B1 may be in contact with the first guide groove G1 and the third guide groove G3, respectively.

Similarly, the second ball group B2 may be disposed between the second guide groove G2 and the fourth guide groove G4. The second guide groove G2 and the fourth guide groove G4 may face each other in the first axis (X-axis) direction with the second ball group B2 therebetween, and at least some of the plurality of balls constituting the second ball group B2 may contact the second guide groove G2 and the fourth guide groove G4, respectively.

When the driving force is generated by the driving magnet 1410 and the driving coil 1420, the first ball group B1 and the second ball group B2 may guide the movement of the carrier 1300 or the like in the optical axis (Z-axis) direction, while performing a rolling motion along the guide groove in the optical axis (Z-axis) direction.

Referring to FIG. 6, the case 1130 may include damper members provided in positions facing the first ball group B1 and the second ball group B2 in the direction of the optical axis (Z-axis). For example, the damper member may include a first damper member 1131 provided on the upper side of the first ball group B1 and a second damper member 1132 provided on the upper side of the second ball group B2.

The first damper member 1131 and the second damper member 1132 may be formed to protrude from the lower surface of the case 1130 toward the first ball group B1 and the second ball group B2.

The first damper member 1131 and the second damper member 1132 may function as stoppers that limit the range of movement of the carrier 1300 in the optical axis (Z-axis) direction and may prevent the first ball group B1 and the second ball group B2 from being separated outside the carrier 1300. For example, the carrier 1300 may be moved in the optical axis (Z-axis) direction until the first ball group B1 and/or the second ball group B2 come into contact with the first damper member 1131 and the second damper member 1132. For example, a maximum movement distance (stroke) of the carrier 1300 may approximately match the gap between the first ball group B1 and the first damper member 1131 and/or the second ball group B2 and the second damper member 1132. In addition, the gap between the first ball group B1 and the first damper member 1131 and/or the second ball group B2 and the second damper member 1132 may be smaller than the diameter of the balls constituting the first ball group B1 and the second ball group B2.

The first damper member 1131 and the second damper member 1132 may be formed of different materials from the case 1130. For example, the first damper member 1131 and the second damper member 1132 may be formed of an elastic material (a material that may be deformed) that is advantageous for shock and noise absorption, and may be insert-molded into the case 1130.

The yoke 1440 may be disposed in the housing 1110. For example, the yoke 1440 may be disposed to cover the substrate 1500. The yoke 1440 may face the driving magnet 1410 in the first axis (X-axis) direction with the driving coil 1420 therebetween.

The yoke (second magnetic member) 1440 may generate a magnetic attraction with the driving magnet (first magnetic member) 1410. An attractive force may be generated between the yoke 1440 and the driving magnet 1410 in the first axis (X-axis) direction, which is the direction in which they face each other. With the attractive force, one side surface of the carrier 1300 may be closely supported by one side surface of the housing 1100 with the guide member therebetween. Accordingly, the guide member may maintain a state of contact with the carrier 1300 and the housing 1100.

Additionally, the yoke 1440 may focus the magnetic force of the driving magnet 1410. For example, the yoke 1440 and the driving magnet 1410 may form a magnetic circuit.

Referring to FIG. 7, one side of the driving magnet 1410 may face the yoke 1440, and the other side surface may face the back yoke 1340 provided on the carrier 1300. The back yoke 1340 may focus the magnetic force of the driving magnet 1410 on the opposite side of the yoke 1440.

The camera module 100 according to an embodiment may include a position sensor 1430 that detects the position of the lens unit 1200.

The position sensor 1430 may be disposed on the substrate 1500 together with the driving coil 1420, and may be disposed on the housing 1110 via the substrate 1500. The position sensor 1430 may be exposed to the internal space of the housing 1110 through the second through-hole 1112 together with the driving coil 1420.

The position sensor 1430 may detect the position of the lens unit 1200 by detecting a change in the magnetic flux generated from the driving magnet 1410. For example, the position sensor 1430 may be provided as a hall sensor.

The camera module 100 according to an embodiment may use a closed-loop control method that detects and feeds back the position of the lens unit 1200.

When the camera module 100 is powered on, the initial position of the lens unit 1200 may be detected by the position sensor 1430, and the lens unit 1200 may move from the detected initial position to the initial set position. In this case, the initial position refers to the position in the optical axis (Z-axis) direction of the lens unit 1200, and the initial setting position may refer to the position where the focus of the lens unit 1200 becomes infinite. The lens unit 1200 may move from the initial setting position to the target position by the driving signal of the circuit element that provides the driving signal to the driving unit 1400. The lens unit 1200 may move in both directions (±Z direction) in the optical axis (Z-axis) direction during the auto-focusing process.

The camera module 100 according to an embodiment may include a ball damper BD.

The ball damper BD may be disposed on the side facing the guide member (or on the opposite side thereto) based on the lens unit 1200. Referring to FIG. 5, the ball damper BD and the guide member may be disposed on opposite sides based on a virtual straight line extending in the second axis (Y-axis) direction passing through the center of the lens unit 1200. For example, the ball damper BD and the guide member may be disposed spaced apart in the first axis (X-axis) direction.

The ball damper BD may be disposed in the receiving groove 1330 provided in the carrier 1300. The receiving groove 1330 may also be disposed spaced apart from the third guide groove G3 and the fourth guide groove G4 in the first axis (X-axis) direction.

The ball damper BD may face one side surface of the housing 1110 in a direction perpendicular to the optical axis (Z-axis) in a state where it is disposed in the receiving groove 1330.

In an embodiment, a portion of the ball damper BD may be provided between the carrier 1300 and the housing 1110 in a state where the ball damper BD is disposed in the receiving groove 1330. Therefore, referring to FIG. 7, the gap (shortest distance) d1 formed in a direction perpendicular to the optical axis (Z-axis) between the ball damper BD and the housing 1110 may always be narrower than the gap (shortest distance) d2 formed in the same direction between the carrier 1300 and the housing 1110.

In addition, in an embodiment, the ball damper BD may be disposed movably in the receiving groove 1330. For example, the ball damper BD may be disposed in the receiving groove 1330 to be movable on a plane perpendicular to the optical axis (Z-axis), which is related to the assembly process of the camera module 100 and may be for resolving assembly tolerance.

The camera module 100 according to an embodiment may be assembled in the order of a carrier 1300, a guide member (a first ball member B1 and a second ball member B2), a ball damper BD, a lens unit 1200, and a case 1130 (hereinafter, a description of the assembly process of the lens unit 1200 and the case 1130 is omitted).

First, the carrier 1300 may be disposed in the internal space of the housing 1110. The carrier 1300 may be disposed so that one side surface where the driving magnet 1410 is disposed faces one side surface of the housing 1110 where the yoke 1440 is disposed. The driving magnet 1410 and the yoke 1440 may generate an attractive force in the direction of facing each other, and accordingly, one side surface of the carrier 1300 may be in close contact with the housing 1110. For example, the carrier 1300 may be pressed against the housing 1110 in the first axis (X-axis) direction.

The guide member may be assembled between one side surface of the carrier 1300 and one side surface of the housing 1110 facing the same. The one side surface of the carrier 1300 and the one side surface of the housing 1110 facing the same may be provided with guide grooves facing each other, and the guide member may be assembled between the guide grooves facing each other.

To assemble the guide member, a process of pressing the other side surface of the carrier 1300 to the housing 1110 may be performed. In this case, the other side surface may refer to a surface parallel to the one side surface of the carrier 1300 provided opposite the one side surface of the carrier 1300. Therefore, a space may be formed between the one side surface of the carrier 1300 and the one side surface of the housing 1110 facing the same, and the guide member may be inserted into the space.

The ball damper BD may be assembled between the other side surface of the carrier 1300 and one side surface of the housing 1110 facing the same. For example, the ball damper BD may be assembled to the receiving groove 1330 provided in the carrier 1300. In an embodiment, the receiving groove 1330 may be provided on the other side surface of the carrier 1300. However, in this case, the other side surface does not necessarily have to be a surface parallel to the one side surface of the carrier 1300, provided on the opposite side of the one side surface of the carrier 1300, and may mean any surface located opposite the one side surface of the carrier 1300 based on a virtual straight line extending in the direction of the second axis (Y-axis) passing through the center of the lens unit 1200.

Meanwhile, the carrier 1300 may be provided to be movable in the direction of the optical axis (Z-axis) with respect to the housing 1110. Therefore, for smooth movement of the carrier 1300, the remaining side surface(s) of the carrier 1300 except for the one side surface of the carrier 1300 supported by the housing 1110 may be disposed with a gap between such remaining side surface(s) of the carrier and the housing 1110. For example, a gap in a direction perpendicular to the optical axis (Z-axis) may be formed between the remaining side surface(s) of the carrier 1300 and the housing 1110.

The ball damper BD may be disposed such that a portion thereof is provided between the carrier 1300 and the housing 1110, on the opposite side of the one side surface of the carrier 1300, thereby narrowing the gap between the carrier 1300 and the housing 1110.

The ball damper BD may reduce the shock transmitted to parts disposed in the carrier 1300, particularly, the guide member, by narrowing the gap formed between the carrier 1300 and the housing 1110 when an impact occurs. In detail, the gap d1 between the ball damper BD and the housing 1110 is always formed narrower than the gap d2 between the carrier 1300 and the housing 1110, so that when an impact is applied from the outside, the ball damper BD collides with the housing 1110 instead of the carrier 1300, so that the shock transmitted to the guide member may be reduced. In addition, since the moving distance of the carrier 1300 is reduced, the amount of shock due to the collision may also be reduced.

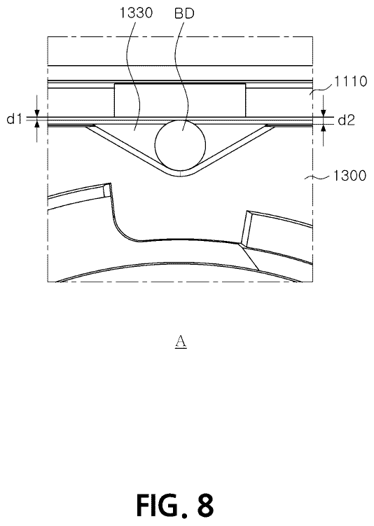

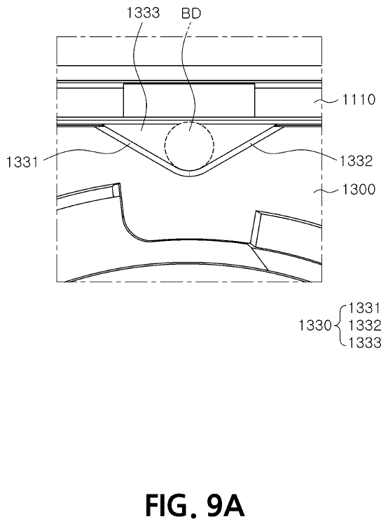

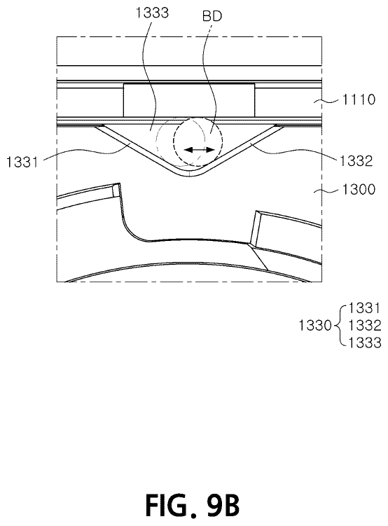

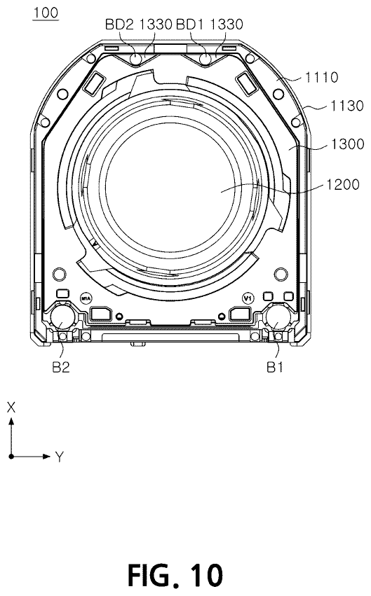

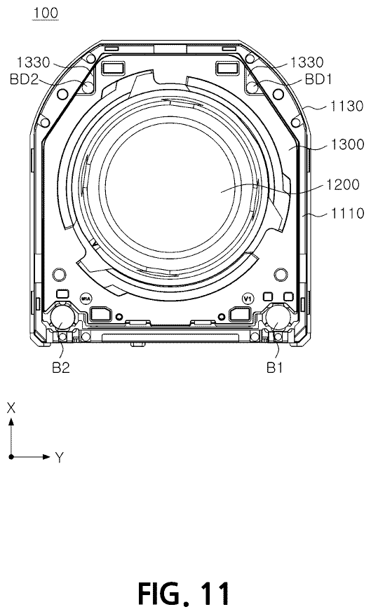

FIG. 8 is an enlarged view of part A of FIG. 5, and FIGS. 9A and 9B are drawings illustrating positions of a ball damper according to an embodiment, and FIGS. 10 and 11 are drawings illustrating modified examples of part A of FIG. 5.

In an embodiment, the receiving groove 1330 may include a bottom surface 1333 facing the case 1130 in the direction of the optical axis (Z-axis) and a plurality of side surfaces 1331 and 1332 facing the housing 1110 in the direction perpendicular to the optical axis (Z-axis).

The bottom surface 1333 may be provided at a lower height in the direction of the optical axis (Z-axis) than the upper surface of the carrier 1300.

The plurality of side surfaces 1331 and 1332 may include a first side surface 1331 and a second side surface 1332 having an angle therebetween. For example, the angle between the first side surface 1331 and the second side surface 1332 may be 90 degrees or more. Therefore, when viewed from the optical axis (Z-axis) direction, the cross section of the receiving groove 1330 may be a right triangle or an obtuse triangle shape.

The ball damper BD may move in a direction perpendicular to the optical axis (Z-axis) in a space provided between the first side surface 1331, the second side surface 1332, and one side surface of the housing 1110 facing the first side surface 1331 and the second side surface 1332 in a direction perpendicular to the optical axis (Z-axis). For example, the ball damper BD may roll on a plane (X-Y plane) perpendicular to the optical axis (Z-axis).

As described above, this is to resolve the assembly tolerance according to the assembly process of the camera module 100, and the amount of movement may be so small that it does not interfere with the operation.

In an embodiment, the ball damper BD may be moved approximately in a first axis (X-axis) direction between the plurality of side surfaces 1331 and 1332 and one side surface of the housing 1110, and may be moved approximately in a second axis (Y-axis) direction between the plurality of side surfaces 1331 and 1332.

Meanwhile, depending on the position of the ball damper BD, a gap d1 may be formed between the ball damper BD and the housing 1110 in a direction perpendicular to the optical axis (Z-axis).

The gap d1 between the ball damper BD and the housing 1110 may be maximum when the ball damper BD is at the position of FIG. 9A, and minimum when the ball damper BD is at the position of FIG. 9B.

When the ball damper BD is in contact with the first side surface 1331 and the second side surface 1332, respectively, the ball damper BD may be spaced apart from the housing 1110 to the maximum in a direction perpendicular to the optical axis (Z-axis). Even when the ball damper BD is spaced apart from the housing 1110 to the maximum extent, the gap d1 between the ball damper BD and the housing 1110 may be narrower than the gap d2 between the carrier 1300 and the housing 1110 formed in the same direction. Meanwhile, the ball damper BD may be in contact with either the first side surface 1331 or the second side surface 1332 and the housing 1110. A minimum gap between the ball damper BD and the housing 1110 described in this specification may indicate a state in which the ball damper BD is in contact with the housing 1110, for example, a state in which d1=0.

As illustrated in FIGS. 10 and 11, the ball damper BD may be provided in multiple units.

In the embodiments, the ball damper BD may include a first ball damper BD1 and a second ball damper BD2 that are spaced apart in the direction of the second axis (Y-axis).

The receiving groove 1330 may be provided in a number corresponding to the ball dampers BD. The first ball damper BD1 and the second ball damper BD2 may be individually accommodated in the receiving groove 1330.

In the embodiments, the guide member may be provided on one side of the carrier 1300, and the first ball damper BD1 and the second ball damper BD2 may be provided on the other side surface of the carrier 1300.

Referring to FIG. 10, a third guide groove G3 and a fourth guide groove G4 are provided on one side surface of the carrier 1300, and a receiving groove 1330 may be provided on the other side surface of the carrier 1300 that is opposite the one side surface and parallel to the one side surface. The first ball damper BD1 and the second ball damper BD2 may face the housing 1110 in the first axis (X-axis) direction while being accommodated in the receiving groove 1330.

Referring to FIG. 11, the receiving groove 1330 may be provided on one or more side surfaces located on the opposite side of one side surface of the carrier 1300 with respect to the lens unit 1200 among several side surfaces provided between one side surface of the carrier 1300 and the other side surface of the carrier 1300. For example, the receiving groove 1330 may be provided on different sides of the side surfaces. The first ball damper BD1 and the second ball damper BD2 may face the housing 1110 in a direction perpendicular to the optical axis (Z-axis) while being accommodated in the receiving groove 1330. For example, the first ball damper BD1 and the second ball damper BD2 may face the housing 1110 in a direction oblique to the first axis (X-axis) and the second axis (Y-axis).

Meanwhile, the case 1130 may include a damper member provided at a position facing the ball damper BD in the direction of the optical axis (Z-axis). For example, the case 1130 may include a third damper member 1133 provided on the upper side of the ball damper BD. The third damper member 1133 may be provided in a number corresponding to the number of ball dampers BD. The description of the first damper member 1131 and the second damper member 1132 described above may be equally applied to the third damper member 1133.

As set forth above, according to embodiments, since the moving distance of the driving unit is reduced, impact resistance performance may be improved.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a carrier disposed in the housing and configured to move in an optical axis direction with respect to the housing;
a lens unit disposed in the carrier and configured to move in the optical axis direction together with the carrier;
a guide member disposed between the carrier and the housing, that contacts both the carrier and the housing; and
a ball damper disposed spaced apart from the guide member in a direction perpendicular to an optical axis,
wherein the ball damper is configured to move in the carrier, and a gap is formed between the ball damper and the housing according to a position of the ball damper, in a direction perpendicular to the optical axis.

2. The camera module of claim 1, wherein a side surface of the carrier is supported by the housing in a first axis direction, perpendicular to the optical axis,
wherein other side surfaces of the carrier are spaced apart from the housing in a direction perpendicular to the optical axis by a first gap,
wherein a second gap between the ball damper and the housing in a direction perpendicular to the optical axis, is configured to be always less than the first gap formed between the other side surfaces of the carrier and the housing in the direction perpendicular to the optical axis.

3. The camera module of claim 2, wherein the guide member is disposed on a side surface of the carrier, and
the ball damper is disposed to be opposite the guide member based on a virtual straight line passing through a center of the lens unit and extending in a second axis direction, perpendicular to both the optical axis and the first axis.

4. The camera module of claim 3, wherein the carrier comprises a receiving groove,
wherein the receiving groove comprises a space, and
wherein the ball damper is disposed in the space and faces a side surface of the housing.

5. The camera module of claim 4, wherein the receiving groove comprises a plurality of side surfaces facing one side surface of the housing, and
the ball damper is movable between the one side surface of the housing and the plurality of side surfaces of the receiving groove, in a direction, perpendicular to the optical axis.

6. The camera module of claim 4, wherein the ball damper comprises a plurality of ball dampers, and the plurality of ball dampers are disposed spaced apart from each other in the second axial direction.

7. The camera module of claim 6, wherein the carrier comprises a plurality of receiving grooves disposed to be spaced apart from each other in the second axial direction, and
the plurality of ball dampers are disposed in the plurality of receiving grooves, respectively.

8. The camera module of claim 3, further comprising:
a first magnetic member disposed on the side surface of the carrier; and
a second magnetic member disposed on the housing to face the first magnetic member in the first axial direction,
wherein the side surface of the carrier is supported on the housing by attractive force generated between the first magnetic member and the second magnetic member.

9. The camera module of claim 8, wherein the guide member comprises:
a first ball group including a plurality of balls arranged in the optical axis direction; and
a second ball group including a plurality of balls arranged in the optical axis direction, and spaced apart from the first ball group in the second axial direction with the first magnetic member interposed therebetween.

10. The camera module of claim 9, wherein the first magnetic member is a driving magnet,
wherein the housing comprises a driving coil to face the driving magnet in the first axial direction,
wherein the driving magnet and the driving coil are configured to generate a driving force that moves the carrier in the optical axis direction.

11. The camera module of claim 3, further comprising a case coupled to the housing,
wherein the case comprises damper members protruding toward the guide member and the ball damper facing the guide member and the ball damper in the optical axis direction, respectively.

12. The camera module of claim 11, wherein the damper member comprises an elastic material.

13. A camera module comprising:
a housing;
a carrier disposed in the housing and movable in an optical axis direction with respect to the housing;
a lens unit disposed in the carrier and movable in the optical axis direction together with the carrier;
a guide member including a plurality of balls arranged in the optical axis direction and disposed between the housing and the carrier; and
a ball damper disposed in the carrier such that a portion of the ball damper is disposed between the housing and the carrier,
wherein the guide member rolls in the optical axis direction, and the ball damper rolls at least on a plane, perpendicular to an optical axis.

14. The camera module of claim 13, wherein the carrier is supported on the housing in a first axis direction, perpendicular to the optical axis, with the guide member therebetween, and
the guide member and the ball damper are disposed to be spaced apart from each other in the first axis direction.

15. The camera module of claim 14, wherein the guide member and the ball damper are disposed on opposite sides of the carrier from each other based on a virtual straight line extending in a direction, perpendicular to the optical axis passing through a center of the lens unit.

16. The camera module of claim 13, further comprising a case coupled to the housing,
wherein the carrier comprises a receiving groove in which the ball damper is disposed and which comprises a bottom surface facing the case in the direction of the optical axis and a plurality of side surfaces facing the housing in a direction, perpendicular to the optical axis.
